(19) United States
(12) Patent Application Publication
(10) Pub. No.: US 2003/0090439 A1
(43) Pub. Date: May 15, 2003

(54) Light weight, compact, remountable face-supported electronic display

(76) Inventors: Mark B. Spitzer, Sharon, MA (US); Gregory H. Hunter, Dover, MA (US); Paul M. Zavracky, Norwood, MA (US); Gregg Flender, Bedford, MA (US); Sebastian M.J. Petry, Waltham, MA (US); Michel D. Arney, Wellesley, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/237,776

(22) Filed: Sep. 9, 2002

Related U.S. Application Data
(60) Provisional application No. 60/318,190, filed on Sep. 7, 2001.

(51) Int. Cl. G09G 5/00

(52) U.S. Cl. 345/8

(57) ABSTRACT

An electronic imaging system is mountable on a user's head without eyewear. The system provides a computer monitor image or other electronic display, such as television or data display. The system provides many of the functions and advantages of known eyewear-mounted displays, but without requiring the user to wear spectacles. The system can be fit to a wide range of users without prescriptive correction or other customization.

### CROSS REFERENCE TO RELATED APPLICATIONS

Applicants claim priority under 35 U.S.C. §119(e) of U.S. Provisional Application No. 60/318,190, filed Sep. 7, 2001, the disclosure of which is incorporated by reference herein.

### STATEMENT REGARDING FEDERALLY SPONSORED RESEARCH OR DEVELOPMENT

N/A

### BACKGROUND OF THE INVENTION

Many examples of displays mounted on the head, sunglasses, eyeglasses and the like are known. See, for example, U.S. Pat. No. 4,867,551 of Perera. Perera describes a display to be mounted on eyeglasses, the limitation of which is the high degree of occlusion of the user's field of view beyond the display and the use of non-axial optics that introduce distortion. This limitation is also present in an eyeglass-mounted display offered for sale by Albacomp Computers Corp. A number of other displays that use eyeglass frames, goggles or face masks as the support for the display are known. See, for example, U.S. Pat. Nos. 5,886,822 and 6,023,372. There is a wide body of literature as well on helmet and head-mounted displays.

Most head-mounted and helmet-mounted display systems are based on miniature displays having a diagonal dimension of four cm or less. The display systems that use such miniature displays must provide a lens near the eye for magnification and to make possible comfortable viewing at near distances. The lens and any other associated optics that must be placed near the eye are termed the “eyepiece.” Most prior art head-mounted systems also place the display (for example, a miniature liquid crystal flat panel display) near the eye as well, which requires both a support fixture for the eyepiece, and a conduit for electrical cables to the display. These components (wires, liquid crystal display and any other required circuits) are placed within an opaque housing near the eye. Consequently, such systems block a portion of the user's visual field, and also obscure the user's face.

Generally, display systems mounted on fixtures that suspend the system in front of the eye have two additional limitations. First, the placement of an optical system on a long lever arm tends to permit low frequency vibration of the optical system. This vibration or movement of the optics is unacceptable to the user. Second, the suspension of devices in front of the eye of a user who is not wearing glasses could make the user susceptible to an injury to the eye if an impact were to occur.

### SUMMARY OF THE INVENTION

The present invention provides an ultra-light weight, low obscuration display system that can be used by people without the need for eyewear. The display system is useful for users who do not need or use prescriptive correction, sunglasses, safety eyewear and the like. The system can be worn on the head, which does not significantly obscure the field of view of the user, and it does not hide the user's face. It does not introduce susceptibility to impact-related eye injury. The system provides an undistorted image, and it is not susceptible to vibration.

The present display system is a light weight, compact viewing device that combines an image relay system and mechanical support with a simple mounting system that can be applied to the nose, ears and face. The system uses a miniature flat panel display mounted near the temple, combined with a transparent opto-mechanical fixture that suspends the eyepiece near the eye. The system is further mounted on a support structure resting on the ear, nose and face.

In this manner, the present display system is able to provide a user of an electronic device with an image conveying data, video images, pictures, or other optical information in a compact, ergonomic manner. The system provides an image in a see-through manner, so that the user sees a superposition of the image from the display on the ambient image. The system allows a user to position the image in a convenient location in the user's field of view. The system provides a light-weight device that can be added to or removed from the head easily with little discomfort to the user, and which is stable when in use.

### DESCRIPTION OF THE DRAWINGS

The invention will be more fully understood from the following detailed description taken in conjunction with the accompanying drawings in which:

FIG. 1A is a plan view of a display system according to the present invention;

FIG. 1B is a right side view of the display system of FIG. 1A;

FIG. 1C is a front view of the display system of FIG. 1A;

FIG. 1D is a partial left side view of the display system of FIG. 1A illustrating an audio speaker housing;

FIG. 2 is schematic view of a display unit for use with the display system of the present invention;

FIG. 3 is a schematic view of a display unit and lens system for use with the display system of the present invention;

FIG. 4 is a further embodiment of a display unit and lens system;

FIG. 5 is a still further embodiment of a display unit and lens system; and

FIG. 6 is a still further embodiment of a lens system having angled edges.

### DETAILED DESCRIPTION OF THE INVENTION

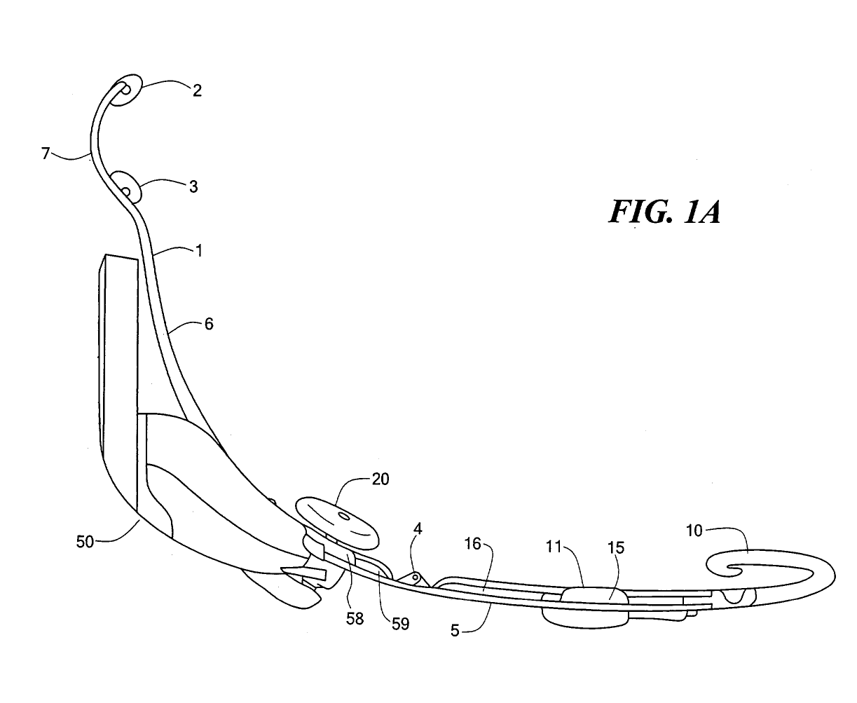

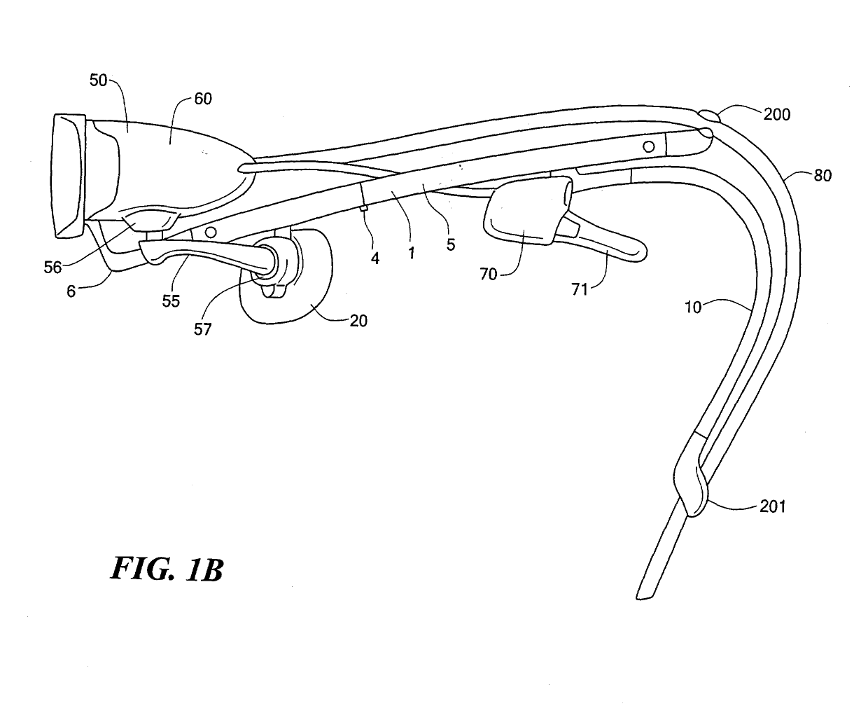

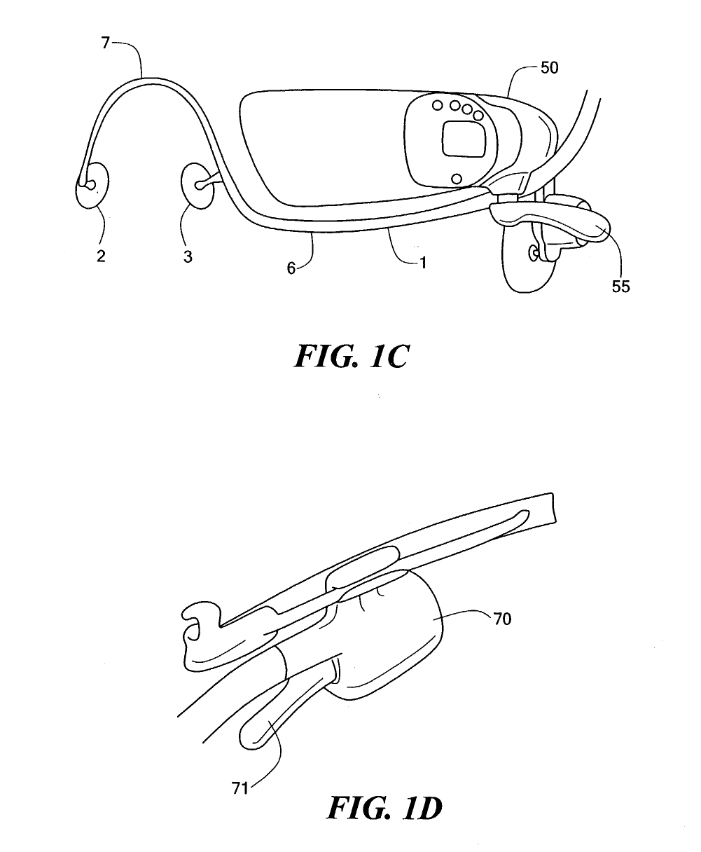

The display system of the present invention is illustrated in FIGS. 1A-1C. A frame 1 is configured to be supported on the ear, nose, and face of the user. In the embodiment illustrated, the frame has a temple portion 5 and a face portion 6 that includes a nose bridge 7. Nose pads 2,3 are provided on the nose bridge that function in a manner similar to spectacle nose pads. A support 10 is configured to hold the frame over the ear. The support 10 is fixed to the temple piece of the frame 1 by a sliding mechanism 11 so that the exact position of the support 10 with respect to the nose pads 2,3 is adjustable. For example, the sliding mechanism may include a tab 15 that is retained within and travels along a slot 16 in the frame. A hinge 4 may be used to facilitate storage.

A display unit 50 is attached to the frame by an adjustable mount 55, so that its position with respect to the user's eye may be adjusted, described further below. A chief requirement of such a system is a degree of stability such that small movements of the optical system, if any, are not detectable by the eye. Instability in the position of the display system leads to a number of problems in the image. Therefore, the display system of the present invention increases the stability of the frame 1 so that the instability problem in prior art displays is overcome.

The frame 1 includes a sliding face pad 20 that rests against the face of the user, preferably against the skin over one of the zygomatic bones. Face pad 20 adds the necessary stability to the system that makes possible the use of a high resolution display unit 50 mounted to the frame 1. The frame 1 also makes contact with the face at the nose pads 2, 3 and at the ear using a support 10 in the form of a flexible ear attachment or arm. In this manner, the frame contacts the head in three places: at the nose, the ear, and the skin over the zygomatic bones, which makes the present system distinct from prior head mounted display mounting fixtures.

FIGS. 1A-1C show the display unit 50 supported by the adjustable mount attachment 55. The adjustable mount includes a sliding tab 58 that is retained within a slot 59 on the frame for travel between ends of the slot to allow for adjustment between a range of positions. Preferably, the housing 60 is mounted on the adjustable mount with a ball joint 56, and the face pad 20 is also mounted on the adjustable mount 55 with a ball joint 57, to improve the adjustment range of the display unit position. These adjustments make it easier for the user to position the image in a preferred location. The display unit and face pad can be mounted in any other suitable manner, as will be appreciated by those of skill in the art.

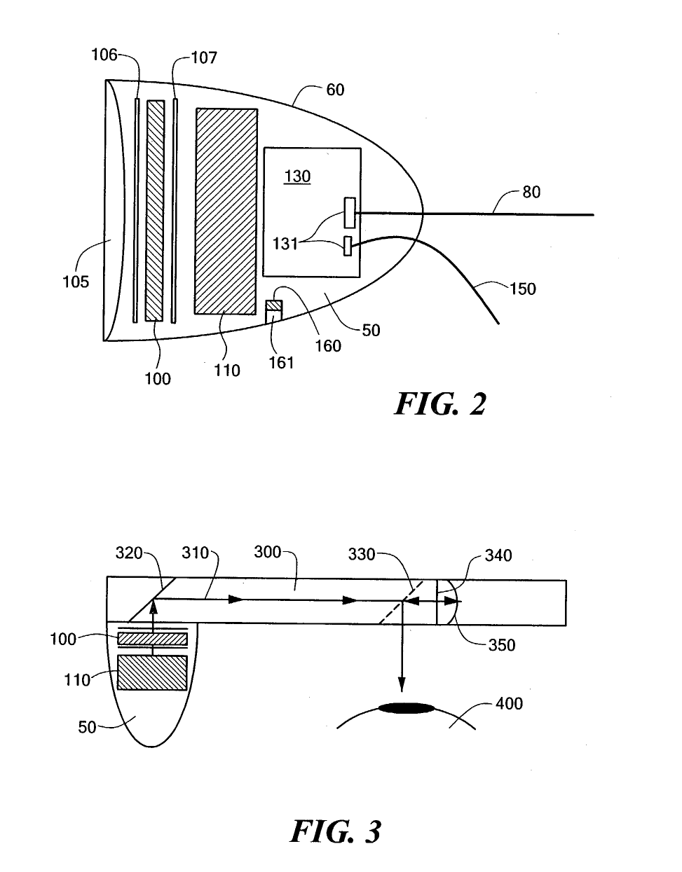

The display unit 50 is provided with a housing 60 that contains a miniature display and associated electronics and optics for generating an image. An exemplary display unit is shown in FIG. 2. This unit employs a CyberDisplay liquid crystal display 100 manufactured by Kopin Corporation of Taunton, Mass. An LED backlight 110 is provided to illuminate the display. Optical films 106, 107 are provided for polarization. Lenses 105, electrical circuitry 130, and cable terminations 131 are also provided. In the example, cable 80 supplies audio and video signals to the display housing, and cable 150 provides the audio signals to an external transducer, such as an earpiece. The system may also include a microphone 160 positioned near a port 161 for speech input. In this case, the signal is provided to external electronics by the cable 80.

FIGS. 1B and 1D illustrate the audio speaker housing 70 that may be attached to the frame 1 with a sliding mechanism for adjustability. The housing 70 includes an internal miniature speaker that is in communication with the user's ear by an acoustic pipe 71. The pipe 71 does not need to be in contact with the user's ear. Once the pipe position is adjusted with respect to the ear, the system may be placed on or taken off the head without readjustment of the audio subsystem. Alternatively, for high noise environments, the pipe 71 may be provided with an earplug that fits into the ear to block ambient noise. Such earplugs are well known in the art.

The flexible ear attachment or arm may be covered with a compliant material and holds the frame 1 in place over the user's ear. The arm 10 acts as both a securing feature and a cable dressing feature, organizing the cable 80 so that it travels over and behind the ear comfortably. Cable retaining members 200, 201 are provided on the end of the temple portion of the frame and the ear attachment. The cable fits with the retaining members in a freely slidable manner.

In alternative embodiments, data or images may also be relayed to the device by a cable 80 that may comprise wire, one or more optical fibers as described in U.S. Pat. No. 5,715,337, or a fiber optic coherent bundle image conduit. In another embodiment, the image is relayed to the device by radio frequency (RF) transmission.

The imaging element may alternatively comprise a reflective liquid crystal display, organic or inorganic light emitting diode array, field emission display, CRT, or electro-luminescent display, or the scanning display described in U.S. Pat. No. 5,715,337.

Referring to FIG. 3, light from the display unit 50 is relayed to the eye of the user 400 through a lens assembly. The lens assembly includes a relay lens 300 that directs light to an eyepiece within the lens. In the embodiment illustrated, the eyepiece comprises a polarization beam splitter 330, a quarter wave plate 340, and a magnifying mirror 350. The light rays 310 are first turned by mirror 320, then pass through polarization beam splitter 330 and quarter wave plate 340, and then are reflected from mirror 350. Mirror 350 preferably has a curvature to magnify the image. The reflected light passes through quarter wave plate 340 and, having passed twice through the quarter wave plate 340, has its axis of polarization rotated so that the light is then reflected by the beam splitter 330, toward the eye of the user. This optical system provides the user with a “see-through” eyepiece, meaning that ambient rays of the proper polarization can pass through the eyepiece. Lenses and eyepieces of this type have been described in U.S. Pat. No. 5,886,822. The user perceives a virtual image in space in front of the eyepiece.

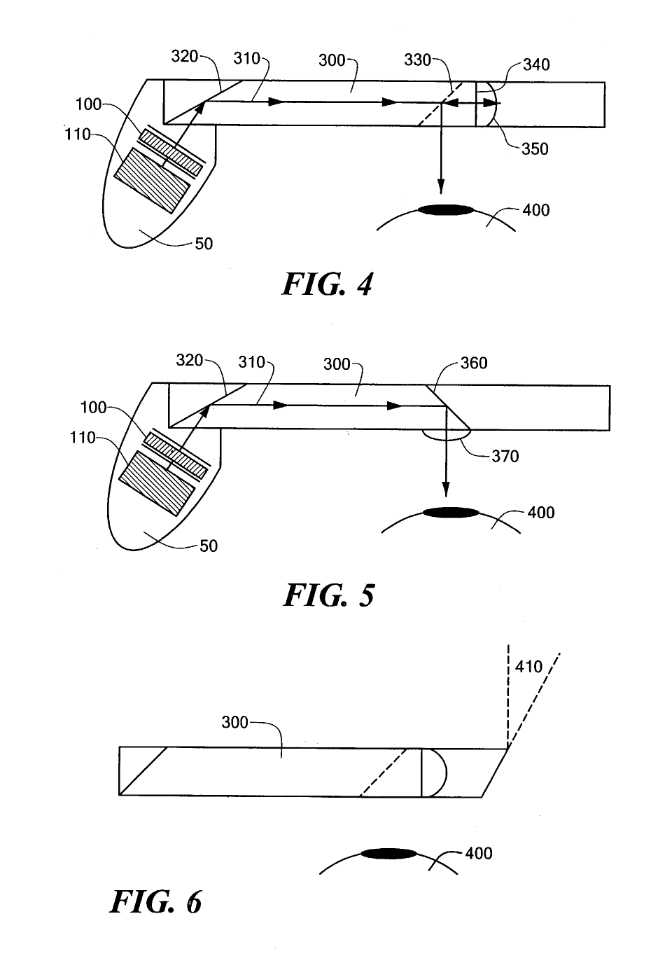

Additionally, the invention described herein is very small, particularly because the display and backlight within the enclosure 50 are moved to the side of the user's head, so that the amount of structure in front of the user's eye is minimal, as shown in FIG. 3. The display unit 50 may also be mounted at an angle with respect to the lens 300, to create a more ergonomic design, so long as the angle of the turning mirror 320 is appropriately adjusted. See FIG. 4.

With reference to FIG. 3, it can be seen that a fundamental difference between the present display system and prior art displays intended to be mounted upon the head is that the present display system utilizes a largely transparent optical relay lens 300. This relay serves both as a mechanism for transmitting the image to the eyepiece, and also as a structural member for protecting the eye from impact. Additionally, the frame 1 is designed so that an impact upon the frame or lens 300 does not push the frame or lens into the eye. This can be accomplished by limiting the travel of the joints 56, 57 and the sliding mechanism, and by inclusion of travel-limiting stops. Alternatively, the lens may be made large enough that in the event of an impact, the lens hits the facial bones, which prevent the lens from touching the eye.

Because the lens 300 is transparent and light in weight, the occlusion of the user's visual field is minimal or, for certain designs, zero, and the obscuration of the user's face is minimal.

FIG. 5 illustrates another embodiment of the image generating system and optics. In this embodiment, the eyepiece comprises a mirror 360 and eye lens 370 for magnifying the image. Other optical approaches are possible, including the use of diffractive or holographic optical elements. The distance of the virtual image may be set by selection of the focal length of the lenses 370. Other folds using mirrors may be added to the optical path to relay the light on other optical paths if desired, or the light may be relayed by total internal reflections occurring along the sides of the lens 300.

The edges of the lens 300 may be ground at an angle to decrease the visibility of the lens edge, as shown in FIG. 6. The lens 300 is provided with an edge at an angle 410 to make the edge less obvious to the eye, when the eye rotates to a position in which the edge can be viewed.

The invention is not to be limited by what has been particularly shown and described, except as indicated by the appended claims.

What is claimed is:

1. A head-supported electronic display system comprising:
a frame comprising a support member and three support elements mounted on the support member, the three support elements configured to support the frame on a user's head at three discrete locations; and
a display assembly mounted on the support member, the display system comprising an image generator and a lens assembly comprising a solid optical relay lens and an eyepiece.

2. The system of claim 1, wherein the three support elements comprise:
a nose support;
an ear support; and
a cheek support.

3. The system of claim 2, wherein the ear support is adjustably mounted to the support member of the frame.

4. The system of claim 2, wherein the support member includes a slot; and
the ear support includes a tab slidably received within the slot for travel along the length of the slot.

5. The system of claim 2, wherein:
the ear support includes a flexible arm shaped to fit over and behind an ear of the user.

6. The system of claim 5, further comprising a compliant material covering the flexible arm.

7. The system of claim 2, further comprising a speaker mounted to the ear support.

8. The system of claim 7, wherein the speaker further includes an acoustic pipe in communication with the user's ear.

9. The system of claim 2, wherein the cheek support comprises a cheek pad configured to rest against skin over a zygomatic bone of the user's face.

10. The system of claim 2, wherein the cheek support is adjustably mounted to the support member of the frame.

11. The system of claim 2, wherein:
the support member includes a slot; and
the cheek support includes a tab slidably received within the slot for travel along the length of the slot.

12. The system of claim 2, wherein the cheek support includes an adjustably mounted cheek pad.

13. The system of claim 2, wherein:
the display system is supported on a mount; and
the cheek support is supported on the mount.

14. The system of claim 13, wherein the display system is adjustably supported on the mount.

15. The system of claim 13, wherein the cheek support further includes a cheek pad adjustably supported on the mount.

16. The system of claim 2, wherein:
the display assembly further includes a cable in communication with the image generator; and
the ear support includes a cable retaining member configured to retain the cable generally adjacent the support member.

17. The system of claim 1, wherein the support member of the frame comprises a temple portion and a face portion.

18. The system of claim 1, wherein:
the support member of the frame comprises a temple portion and a face portion;
a first of the three support elements comprises a nose support mounted to the face portion;
a second of the three support elements comprises a cheek support mounted to the face portion; and
a third of the three support elements comprises an ear support mounted to the temple portion.

19. The system of claim 1, wherein:
the support member of the frame comprises a temple portion and a face portion; and
a hinge is located at an intermediate position along the temple portion, whereby the support member is foldable.

20. The system of claim 1, wherein the image generator is disposed on the support member at a peripheral position to the user's field of view.

21. The system of claim 1, wherein the image generator is disposed on the support member at a location that does not obscure the user's eye.

22. The system of claim 1, wherein the image generator comprises a transmissive liquid crystal display, a reflective liquid crystal display, an organic light emitting diode array, an inorganic light emitting diode array, a field emission display, a cathode ray tube, an electro-luminescent display, or a scanning display.

23. The system of claim 1, further comprising a cable in communication with the display assembly, and the support member further includes a cable retaining member configured to retain the cable generally adjacent the support member.

24. The system of claim 1, further comprising a cable in communication with the image generator to provide video signals.

25. The system of claim 1, further comprising a speaker mounted to the frame.

26. The system of claim 1, further comprising a cable in communication with the speaker to provide audio signals.

27. The system of claim 1, wherein the speaker includes an acoustic pipe in communication with the user's ear.

28. The system of claim 1, further comprising a cable operative to provide video and audio signals.

29. The system of claim 1, wherein the eyepiece further comprises a polarization beam splitter, a quarter wave plate, and a magnifying mirror to direct a magnified image from the image generator to the user's eye.

30. The system of claim 29, wherein the eyepiece further includes a reflecting surface in the solid optical relay lens to direct a light path from the image generator along the solid optical relay lens.

31. The system of claim 1, wherein the solid optical relay lens is sufficiently large to contact facial bones of the user's face in an impact.

32. The system of claim 1, wherein the solid optical relay lens is adjustably mounted to the frame.
